(19) United States
(12) Patent Application Publication
(10) Pub. No.: US 2025/0310490 A1
(43) Pub. Date: Oct. 2, 2025

(54) PROJECTION METHOD AND PROJECTION DEVICE

(71) Applicant: SEIKO EPSON CORPORATION, Tokyo (JP)

(72) Inventor: Kota TAKEUCHI, AZUMINO-SHI, (JP)

(21) Appl. No.: 19/087,801

(22) Filed: Mar. 24, 2025

(30) Foreign Application Priority Data
Mar. 28, 2024 (JP) 2024-053377

(51) Int. Cl. H04N 9/31

(52) U.S. Cl. CPC H04N 9/3147; H04N 9/3182; H04N 9/3185; H04N 9/3188

(57) ABSTRACT

A projection method includes: detecting a projection target; specifying a first region in which an obstacle is not present in the projection target and a second region in which the obstacle is present in the projection target based on a result of detecting the projection target; projecting a first projection image in a part or an entirety of the first region; and projecting a second projection image that is different from the first projection image and indicates that the obstacle is present in the projection target.

The present application is based on, and claims priority from JP Application Serial Number 2024-053377, filed Mar. 28, 2024, the disclosure of which is hereby incorporated by reference herein in its entirety.

### BACKGROUND

### 1. Technical Field

The present disclosure relates to a projection method and a projection device.

### 2. Related Art

In the related art, a technique of changing a projection position if an obstacle is present on a projection surface when a projector projects a projection image onto the projection surface has been known.

For example, JP-A-2004-48694 discloses a technique in which, when an obstacle is present on a projection surface, a projectable region in which the obstacle is not present is determined based on sensing information obtained by sensing a projection target region, and a projection region that is a region in which the projection is actually performed is selected from the projectable region.

However, in the technique according to JP-A-2004-48694, when it is unclear which object the projector has recognized as an obstacle, the user does not know the basis for determining the projectable region, making it difficult to determine whether appropriate control is performed.

### SUMMARY

A projection method according to one aspect of the present disclosure includes: detecting a projection target; specifying a first region in which an obstacle is not present in the projection target and a second region in which the obstacle is present in the projection target based on a result of detecting the projection target; projecting a first projection image in a part or an entirety of the first region; and projecting a second projection image that is different from the first projection image and indicates that the obstacle is present in the projection target.

A projection device according to one aspect of the present disclosure executes detection of a projection target, specifying of a first region in which an obstacle is not present in the projection target and a second region in which the obstacle is present in the projection target based on a result of detecting the projection target, projection of a first projection image in a part or an entirety of the first region, and projection of a second projection image that is different from the first projection image and indicates that the obstacle is present in the projection target.

### BRIEF DESCRIPTION OF THE DRAWINGS

FIG. 1 is a diagram illustrating a configuration example of a projection device 1A.

FIG. 2 is a block diagram illustrating a configuration example of a control device 10A.

FIG. 3A is a diagram illustrating a captured image GI by an image-capturing device 20.

FIG. 3B is a diagram illustrating an example of a detection by a detector 122.

FIG. 4A is a diagram illustrating an example of a detection by the detector 122.

FIG. 4B is a diagram illustrating an example of a calculation by a calculator 124.

FIG. 5A is a diagram illustrating an example of a calculation by the calculator 124.

FIG. 5B is a diagram illustrating a detection example of a maximum region MM.

FIG. 5C is a diagram illustrating an example of a projection image PI.

FIG. 6A is a diagram illustrating an example of the projection image PI in a panel coordinate system.

FIG. 6B is a diagram illustrating an example of an indication image II in the panel coordinate system.

FIG. 6C is a diagram illustrating an example of the projection image PI and the indication image II in the panel coordinate system.

FIG. 7 is a diagram illustrating an example of the projection image PI (a display image DI) and the indication image II that are displayed on a projection target PO.

FIG. 8 is a diagram illustrating an example of the projection image PI (the display image DI) and the indication image II that are displayed on the projection target PO.

FIG. 9 is a diagram illustrating an example of the projection image PI (the display image DI) and the indication image II that are displayed on the projection target PO.

FIG. 10 is a diagram illustrating an example of the projection image PI (the display image DI) and the indication image II that are displayed on the projection target PO.

FIG. 11 is a block diagram illustrating an example of a configuration of a projector 30.

FIG. 12 is a flowchart illustrating a first operation of the control device 10A.

FIG. 13 is a flowchart illustrating the first operation of the control device 10A.

FIG. 14 is a diagram illustrating an example of the projection image PI (the display image DI) and the indication image II that are displayed on the projection target PO during the first operation.

FIG. 15 is a flowchart illustrating a second operation of the control device 10A.

FIG. 16 is a flowchart illustrating the second operation of the control device 10A.

FIG. 17 is a diagram illustrating an example of the projection image PI (the display image DI) and the indication image II that are displayed on the projection target PO during the second operation.

FIG. 18 is a block diagram illustrating an example of a configuration of a control device 10B.

FIG. 19 is a functional block diagram of a determiner 130B.

FIG. 20 is a block diagram illustrating an example of a configuration of a control device 10C.

FIG. 21 is a block diagram illustrating an example of a configuration of a control device 10D.

FIG. 22 is a functional block diagram of a determiner 130D.

FIG. 23 is a flowchart illustrating a first operation of the control device 10D.

FIG. 24 is a flowchart illustrating the first operation of the control device 10D.

### DESCRIPTION OF EMBODIMENTS

An aspect for implementing the present disclosure will hereinafter be described with reference to the drawings. In the respective drawings, dimensions and scales of the respective parts are made different from real ones as appropriate. Embodiments to be described later are preferred specific examples of the present disclosure, and therefore various technically preferable limitations are imposed thereon. However, the scope of the present disclosure is not limited to the embodiments unless there is a description that the present disclosure is limited thereto in particular in the following description.

### 1: First Embodiment

### 1-1: Configuration in First Embodiment

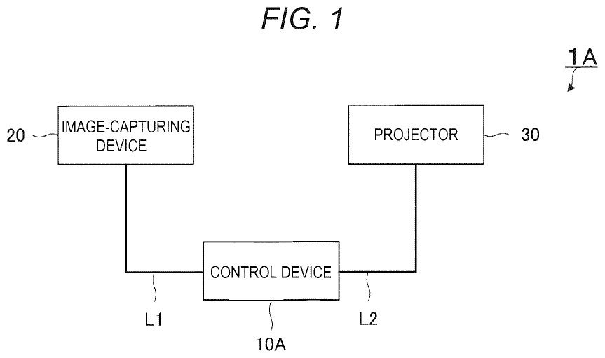

Hereinafter, a projection method and a projection device according to a first embodiment will be described with reference to FIGS. 1 to 17.

### 1-1-1: Overall Configuration of Projection Device

FIG. 1 is a diagram illustrating an example of a configuration of a projection device 1A according to the first embodiment of the present disclosure. As illustrated in FIG. 1, the projection device 1A includes a control device 10A, an image-capturing device 20 that captures images of a projection target PO, and a projector 30 that projects a projection image PI onto the projection target PO.

As illustrated in FIG. 1, the image-capturing device 20 is coupled to the control device 10A via a communication line L1 such as a universal serial bus (USB) cable. The projector 30 is coupled to the control device 10A via a communication line L2 such as a USB cable.

The image-capturing device 20 captures images of the projection target PO. In the present disclosure, the projection target PO is an object with a three-dimensional shape, onto which the projection image PI is to be projected. For example, the projection target PO is a wall or a screen onto which the projection image PI is to be projected. The image-capturing device 20 captures various images under the control of the control device 10A. As will be described later, when the control device 10A is a PC, a tablet terminal, or a smartphone, the image-capturing device 20 may be a camera provided in these devices. However, the image-capturing device 20 is not limited thereto and may be an external camera such as a WEB camera. As will be described later, the image-capturing device 20 may be a stereo camera.

The control device 10A communicates with the image-capturing device 20 via the communication line L1 to acquire a captured image GI of the projection target PO from the image-capturing device 20. The communication between the control device 10A and the image-capturing device 20 may be wireless communication. The control device 10A may be, for example, a personal computer or a tablet terminal.

The projector 30 projects the projection image PI onto the projection target PO. The projector 30 projects various projection images under the control of the control device 10A.

The control device 10A communicates with the projector 30 via the communication line L2 to cause the projector 30 to project the projection image PI onto the projection target PO. The communication between the control device 10A and the projector 30 may be wireless communication.

In FIG. 1, for convenience of description, the control device 10A, the image-capturing device 20, and the projector 30 are illustrated as separate bodies. However, in the projection device 1A, two or more components among these components may be incorporated in a single housing.

### 1-1-2: Overall Configuration of Control Device

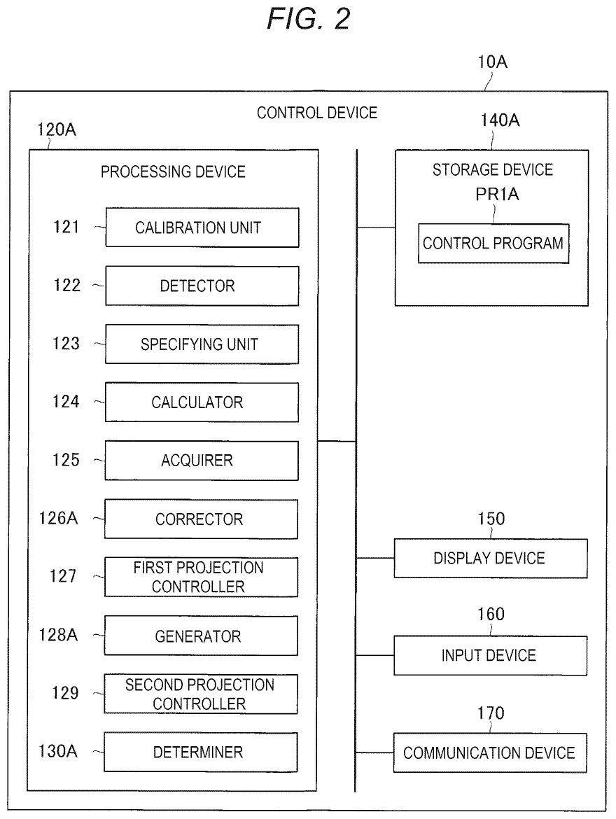

FIG. 2 is a block diagram illustrating an example of a configuration of the control device 10A. The control device 10A is typically a personal computer (PC), but is not limited thereto and may be, for example, a tablet terminal or a smartphone. The control device 10A includes a processing device 120A, a storage device 140A, a display device 150, an input device 160, and a communication device 170. Elements of the control device 10A are coupled via a single bus or a plurality of buses for communicating information.

The processing device 120A is a processor that controls the entire control device 10A and is implemented by, for example, a single chip or a plurality of chips. The processing device 120A is implemented by, for example, a central processing unit (CPU) including an interface with a peripheral device, an arithmetic device, a register, and the like. A part or all of the functions of the processing device 120A may be implemented by hardware such as a digital signal processor (DSP), an application specific integrated circuit (ASIC), a programmable logic device (PLD), or a field programmable gate array (FPGA). The processing device 120A executes various types of processing in parallel or sequence.

The storage device 140A is a recording medium with which the processing device 120A can perform reading and writing and stores a plurality of programs including a control program PR1A to be executed by the processing device 120A. The storage device 140A stores image information indicating an original image RI of the projection image PI. The image information indicating the original image RI is an example of “first image information”.

For example, the storage device 140A may be implemented by at least one of a read only memory (ROM), an erasable programmable ROM (EPROM), an electrically erasable programmable ROM (EEPROM), and a random access memory (RAM). The storage device 140A may be referred to as a register, a cache, a main memory, or a main storage device.

The display device 150 is a device that displays images and character information. The display device 150 may be a display separate from the other components of the control device 10A.

The input device 160 is a device that accepts operations from a user of the projection device 1A. For example, the input device 160 includes a pointing device such as a keyboard, a touchpad, a touch panel, or a mouse. Here, when including a touch panel, the input device 160 may also serve as the display device 150.

The communication device 170 is hardware serving as a transmission and reception device for communicating with other devices. The communication device 170 is also referred to as, for example, a network device, a network controller, a network card, or a communication module. The communication device 170 may include a connector for wired coupling and an interface circuit corresponding to the connector. The communication device 170 may include a wireless communication interface. Examples of the connector for wired coupling and the interface circuit include those conforming to a wired local area network (LAN), IEEE 1394, and a universal serial bus (USB). Examples of the wireless communication interface include those conforming to a wireless LAN or Bluetooth (registered trademark).

By reading the control program PR1A from the storage device 140A and executing the control program PR1A, the processing device 120A functions as a calibration unit 121, a detector 122, a specifying unit 123, a calculator 124, an acquirer 125, a corrector 126A, a first projection controller 127, a generator 128A, a second projection controller 129, and a determiner 130A. The control program PR1A may be transmitted from, via a communication network, another device such as a server that manages the control device 10A.

The calibration unit 121 executes calibration processing to detect a correspondence between a camera coordinate system in the image-capturing device 20 and a panel coordinate system in the projector 30. For example, the calibration unit 121 causes the projector 30 to project a pattern image onto the projection target PO. The pattern image may be, for example, a chessboard pattern, a pattern in which a plurality of circles are arranged, a gray code pattern, or a sine wave pattern. Next, the calibration unit 121 causes the image-capturing device 20 to capture an image of the pattern image projected onto the projection target PO. The calibration unit 121 detects a correspondence between coordinate values in the panel coordinate system of a first feature point in the pattern image projected from the projector 30 and coordinate values in the camera coordinate system of a second feature point in the captured image GI corresponding to the first feature point. The calibration unit 121 detects a plurality of one-to-one correspondences corresponding to a plurality of pairs of the first feature point and the second feature point. Then, the calibration unit 121 detects the correspondence between the camera coordinate system and the panel coordinate system based on the plurality of correspondences.

The calibration unit 121: may detect the correspondence between the camera coordinate system of the image-capturing device 20 and the panel coordinate system of the projector 30 using another method. For example, the calibration unit 121 may detect the above-described correspondence using a part having a characteristic luminance distribution of a normal image instead of the pattern image. Alternatively, the calibration unit 121 may detect a correspondence between all pixels in the camera coordinate system and all pixels in the panel coordinate system by a structured light method used in 3D scanning.

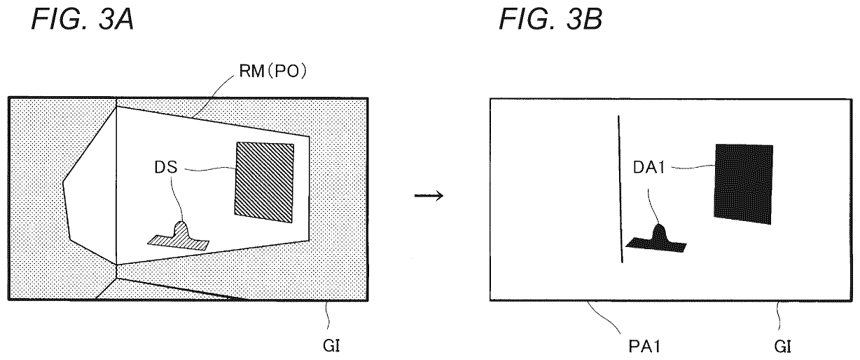

The detector 122 detects the projection target PO. FIG. 3 is a diagram illustrating a detection operation of the detector 122. For example, the detector 122 causes the projector 30 to project white light onto a wall WL. Thereafter, the detector 122 causes the image-capturing device 20 to capture an image of the wall or the screen. FIG. 3A illustrates the captured image GI by the image-capturing device 20. The detector 122 acquires the captured image GI to detect the wall serving as the projection target PO.

In FIG. 2, the specifying unit 123 detects a first obstacle region DA1 indicating a region of an obstacle DO present in a projection region RM of the projection target PO in the captured image GI. The obstacle DO is, for example, a protrusion location, a depression location, or a stain on the wall WL. For example, in FIG. 3A, the specifying unit 123 detects a location that is not white in the captured image GI as the first obstacle region DA1. The first obstacle region DA1 corresponds to a region in which the obstacle DO is present in the projection target PO. The specifying unit 123 detects a region other than the first obstacle region DA1 in the projection region RM as a first non-obstacle region PA1. The first non-obstacle region PA1 corresponds to a region in which the obstacle DO is not present in the projection target PO.

The region in which the obstacle DO is not present in the projection target PO is an example of a “first region FA”. The region in which the obstacle DO is present in the projection target PO is an example of a “second region SA”. In other words, the specifying unit 123 specifies the first region FA and the second region SA in the projection target PO.

FIG. 3B illustrates an example of the first obstacle region DA1 and the first non-obstacle region PA1 detected by the specifying unit 123. In FIG. 3B, the first obstacle region DA1 is illustrated in black. In contrast, in FIG. 3B, the first non-obstacle region PA1 is illustrated in white.

The specifying unit 123 may detect the first obstacle region DA1 using another method. For example, when the image-capturing device 20 is a stereo camera as described above, the specifying unit 123 may calculate a three-dimensional shape of the projection target PO based on the captured image GI by the stereo camera and detect the first obstacle region DA1 based on the calculated three-dimensional shape. Alternatively, the specifying unit 123 may similarly calculate a three-dimensional shape of the projection region RM using a time of flight (TOF) sensor (not illustrated) and detect the first obstacle region DA1 based on the calculated three-dimensional shape.

In FIG. 2, the calculator 124 applies the correspondence between the camera coordinate system and the panel coordinate system, which is detected by the calibration unit 121, to the first obstacle region DA1 and the first non-obstacle region PA1 on the camera coordinate system, which are detected by the specifying unit 123. As a result, the calculator 124 calculates second obstacle region information indicating a second obstacle region DA2 that is an obstacle region on the panel coordinate system and second non-obstacle region information indicating a second non-obstacle region PA2 that is a non-obstacle region on the panel coordinate system.

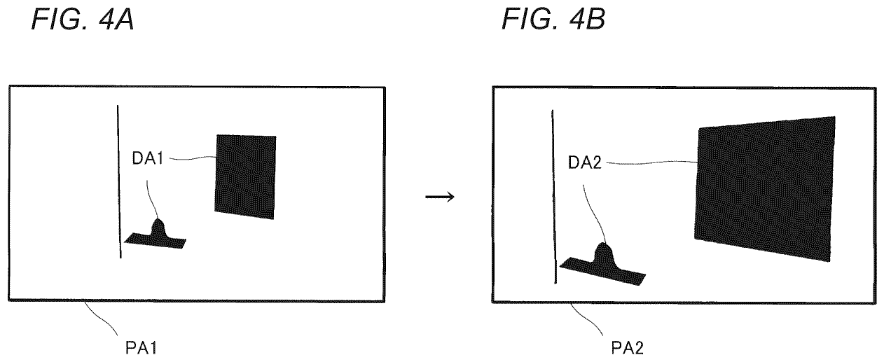

FIG. 4 is a diagram illustrating a calculation operation of the calculator 124. FIG. 4A illustrates the first obstacle region DA1 and the first non-obstacle region PA1 which are the same as those in FIG. 3B. FIG. 4 illustrates the second obstacle region DA2 and the second non-obstacle region PA2 described above. The calculator 124 applies the correspondence between the camera coordinate system and the panel coordinate system to the first obstacle region DA1 and the first non-obstacle region PA1 on the camera coordinate system illustrated in FIG. 4A to perform projective transformation thereon, thereby calculating the second obstacle region DA2 and the second non-obstacle region PA2 on the panel coordinate system illustrated in FIG. 4B.

Alternatively, when the calibration unit 121 detects the correspondence between all pixels in the camera coordinate system and all pixels in the panel coordinate system by the structured light method used in 3D scanning, the calculator 124 may apply the correspondence to all pixels of the first obstacle region DA1 and the first non-obstacle region PA1 to calculate the second obstacle region DA2 and the second non-obstacle region PA2.

In FIG. 2, the acquirer 125 acquires the first image information indicating the original image RI of the projection image PI projected onto the projection target PO. The projection image PI is a projection image mainly projected onto the projection target PO. Further, the projection image PI is an image different from an indication image II to be described later which illustrates that the obstacle DO is present on the projection target PO. The projection image PI is an example of a “first projection image”. The indication image II to be described later is an example of a “second projection image”.

The acquirer 125 may acquire the first image information stored in the storage device 140A. Alternatively, the acquirer 125 may acquire the first image information input from an external device.

When an optical axis of the projector 30 is located obliquely with respect to the projection target PO, and when the projection image PI is projected onto the projection target PO, the display image DI displayed on the projection target PO is not similar in shape to the original image RI indicated by the first image information and is distorted. To make the original image RI and the display image DI similar in shape, it is necessary to generate the projection image PI by performing a keystone correction on the original image RI by geometric transformation. The acquirer 125 acquires keystone correction information required for the keystone correction.

The corrector 126A generates the projection image PI in the panel coordinate system by performing the keystone correction on the original image RI indicated by the first image information acquired by the acquirer 125 using the keystone correction information similarly acquired by the acquirer 125. Then, in the panel coordinate system, the corrector 126A corrects the projection image PI by adjusting a shape of the projection image PI such that the projection image PI falls within the second non-obstacle region PA2 while avoiding the second obstacle region DA2.

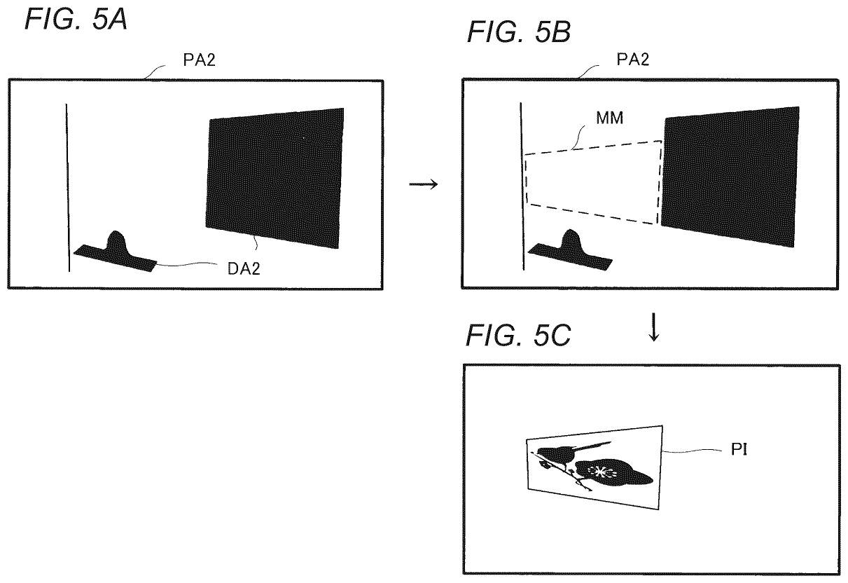

FIG. 5 is a diagram illustrating a correction operation of the corrector 126A. FIG. 5A illustrates the second obstacle region DA2 and the second non-obstacle region PA2 which are the same as those in FIG. 4B. As illustrated in FIG. 5B, the corrector 126A detects a maximum region MM having an aspect ratio of a display screen in the projection target PO and having a shape similar to the shape of the original image RI subjected to the keystone correction in the second non-obstacle region PA2. For example, the corrector 126A detects the second non-obstacle region PA2 from the upper left to the lower right of the second non-obstacle region PA2 and sets a maximum region that satisfies a desired aspect ratio as the maximum region MM. The maximum region MM may be a part of the second non-obstacle region PA2 or the entire second non-obstacle region PA2.

Thereafter, as illustrated in FIG. 5C, the corrector 126A adjusts the shape of the projection image PI according to a dimension and a shape of the maximum region MM.

In FIG. 2, the first projection controller 127 causes the projector 30 to project the projection image PI corrected by the corrector 126A in the first region FA of the projection target PO. The first projection controller 127 may cause the projector 30 to project only the projection image PI after the correction by the corrector 126A onto the projection target PO. Alternatively, the first projection controller 127 may cause the projector 30 to continuously project the projection image PI, which is being corrected by the corrector 126A, onto the projection target PO.

As described above, in the panel coordinate system, the maximum region MM may be a part of the second non-obstacle region PA2 or the entire second non-obstacle region PA2. Therefore, the first projection controller 127 may cause the projection image PI to be projected in a part of the first region FA in which the obstacle DO is not present in the projection target PO, or may cause the projection image PI to be projected in the entire first region FA.

The generator 128A generates the indication image II indicating that the obstacle DO is present in the projection target PO.

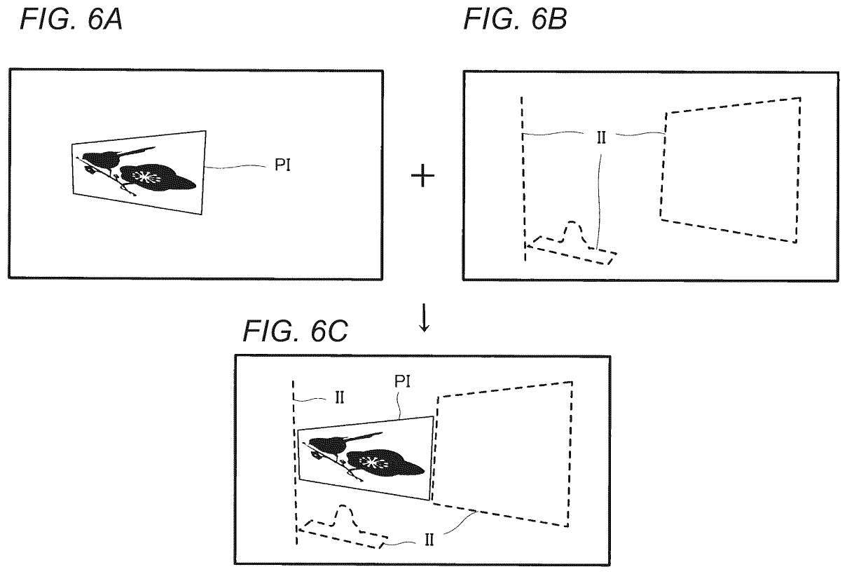

FIG. 6 is a diagram illustrating an example of the projection image PI and the indication image II in the panel coordinate system. FIG. 6A illustrates an example of the same projection image PI as that in FIG. 5C. FIG. 6B illustrates an example of the indication image II. As illustrated in FIG. 6B, for example, the indication image II may be a line image LN surrounding a part or the entirety of the second obstacle region DA2 illustrated in FIG. 4B in the panel coordinate system. In the example illustrated in FIG. 6B, the line image LN is displayed by a dotted line. As a result, as will be described later, in the projection target PO, a part or the entirety of the second region SA is surrounded by the line image LN.

FIG. 6C illustrates both the projection image PI and the indication image II in the panel coordinate system. As illustrated in FIG. 6C, both the projection image PI and the indication image II are formed on a liquid crystal panel to be described later provided in an optical device 310 of the projector 30.

In FIG. 2, the second projection controller 129 causes the projector 30 to project the indication image II onto the projection target PO. For example, the second projection controller 129 causes the indication image II to be projected in the second region SA in the projection target PO.

The second projection controller 129 may cause the indication image II to be projected during the correction of the projection image PI by the corrector 126A, and may end the projection of the indication image II when the correction is ended. In this case, the second projection controller 129 may change a projection mode of the indication image II during the correction of the projection image PI by the corrector 126A. For example, at least one of the shape, hue, brightness, saturation, and luminance of the indication image II may change during the correction. Alternatively, the indication image II may blink.

Alternatively, the second projection controller 129 may not cause the indication image II to be projected during the correction of the projection image PI by the corrector 126A, and may cause the indication image II to be projected when the correction of the projection image PI by the corrector 126A is ended.

The second projection controller 129 may change the projection mode of the indication image II as time passes. For example, at least one of the shape, hue, brightness, saturation, and luminance of the indication image II may change as time passes. Alternatively, the indication image II may blink.

In the above description, for convenience of description, the first projection controller 127 causes the projection image PI illustrated in FIG. 6A to be projected, and the second projection controller 129 causes the indication image II illustrated in FIG. 6B to be projected. However, a single projection controller may cause the projector 30 to project both the projection image PI and the indication image II illustrated in FIG. 6C onto the projection target PO.

Further, in the present disclosure, the projection image PI as the first projection image and the indication image II as the second projection image simply indicate the images themselves. The “projection image” according to the present disclosure does not simply mean the white light projected onto the projection target PO from the projector 30.

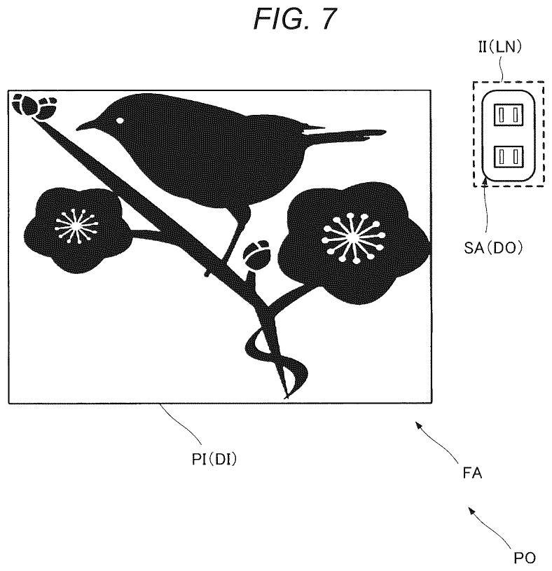

FIGS. 7 to 10 are diagrams illustrating examples of the projection image PI (the display image DI) and the indication image II displayed on the projection target PO.

For example, as illustrated in FIG. 7, the indication image II may be the line image LN surrounding the second region SA.

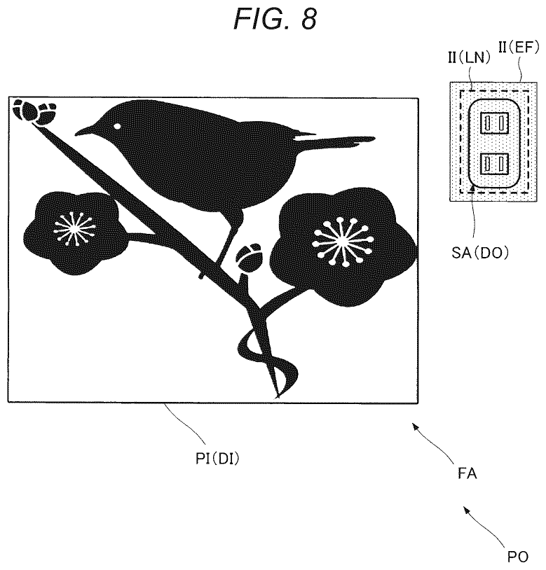

Alternatively, as illustrated in FIG. 8, the indication image II may be the line image LN surrounding the second region SA and a visual effect EF surrounding the second region SA. The visual effect EF may be, for example, a flash image or a blinking image.

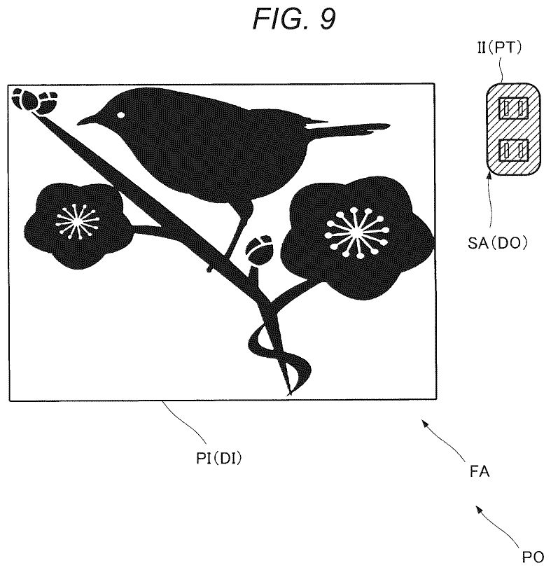

Alternatively, as illustrated in FIG. 9, the indication image II may be a color image PT that fills the second region SA with a single color.

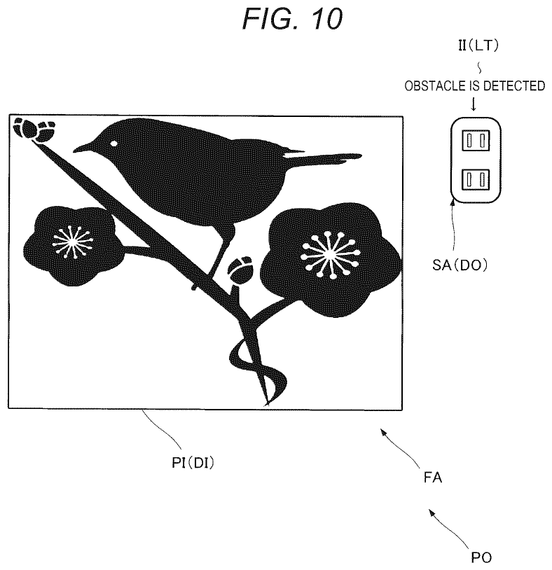

Alternatively, as illustrated in FIG. 10, the indication image II may be a character LT indicating that the obstacle DO is present.

Alternatively, the indication image II may be a combination of the various indication images II illustrated in FIGS. 7 to 10.

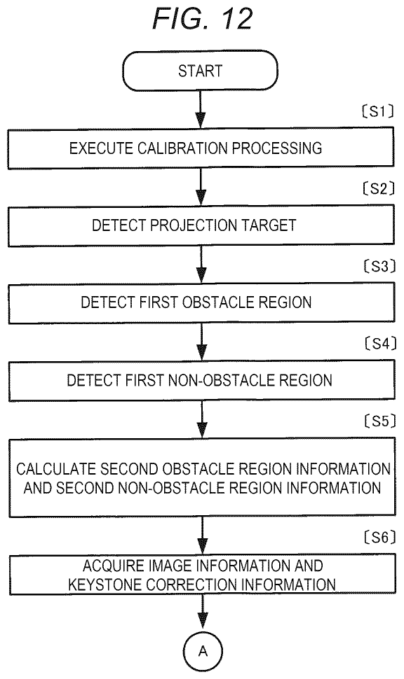

In FIG. 2, the determiner 130A determines whether the operation of correcting the projection image PI is ended. Details of the operation of the determiner 130A, in particular, cooperation with operations of other components will be described later in the description of flowcharts in FIGS. 12, 13, 15, and 16.

### 1-2: Configuration of Projector

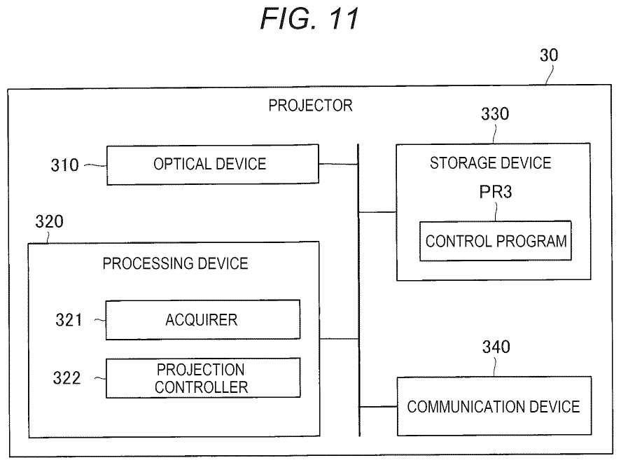

FIG. 11 is a block diagram illustrating an example of a configuration of the projector 30. The projector 30 includes the optical device 310, a processing device 320, a storage device 330, and a communication device 340. Elements of the projector 30 are coupled via a single bus or a plurality of buses for communicating information. Each of the elements of the projector 30 may be implemented by a single or a plurality of devices, and a part of the elements of the projector 30 may be omitted.

The optical device 310 is a device that projects an image indicated by an image signal acquired by an acquirer 321 to be described later onto the projection target PO such as a screen or a wall. The optical device 310 projects various images under the control of the processing device 320. The optical device 310 includes, for example, a light source, a liquid crystal panel, and a projection lens, modulates light from the light source using the liquid crystal panel, and projects the modulated light onto a screen or a wall via the projection lens.

The processing device 320 is a processor that controls the entire projector 30, and is implemented by, for example, a single or a plurality of chips. The processing device 320 is implemented by, for example, a central processing unit (CPU) including an interface with a peripheral device, an arithmetic device, a register, and the like. A part or all of the functions of the processing device 320 may be implemented by hardware such as a DSP, an ASIC, a PLD, or an FPGA. The processing device 320 executes various types of processing in parallel or sequence.

The storage device 330 is a recording medium readable by the processing device 320 and stores a plurality of programs including a control program PR3 to be executed by the processing device 320. The storage device 330 may be implemented by, for example, at least one of a ROM, an EPROM, an EEPROM, a RAM, and the like. The storage device 330 may be referred to as a register, a cache, a main memory, or a main storage device.

The communication device 340 is hardware serving as a transmission and reception device for communicating with other devices. The communication device 340 is also referred to as, for example, a network device, a network controller, a network card, or a communication module. The communication device 340 may include a connector for wired coupling and an interface circuit corresponding to the connector. The communication device 340 may include a wireless communication interface. Examples of the connector for wired coupling and the interface circuit include those conforming to a wired LAN, IEEE 1394, and a USB. Examples of the wireless communication interface include those conforming to a wireless LAN or Bluetooth (registered trademark).

The processing device 320 functions as the acquirer 321 and a projection controller 322 by reading the control program PR3 from the storage device 330 and executing the control program PR3. The control program PR3 may be transmitted from another device such as a server that manages the projector 30 via a communication network.

The acquirer 321 acquires image signals corresponding to the projection image PI and the indication image II and a control signal for controlling the projector 30 from the control device 10A.

The projection controller 322 causes the optical device 310 to project the projection image PI and the indication image II corresponding to the image signals acquired by the acquirer 321 onto an object based on the control signal acquired by the acquirer 321.

### 1-3: Operation of Control Device 10A

### 1-3-1: First Operation

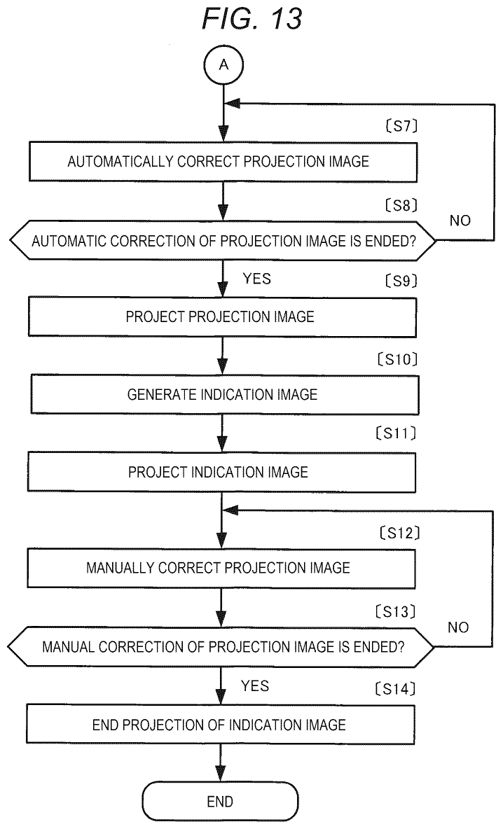

FIGS. 12 and 13 are flowcharts illustrating a first operation of the control device 10A.

In step S1, the processing device 120A functions as the calibration unit 121. The processing device 120A executes the calibration processing to detect the correspondence between the camera coordinate system in the image-capturing device 20 and the panel coordinate system in the projector 30.

In step S2, the processing device 120A functions as the detector 122. The processing device 120A detects the projection target PO.

In step S3, the processing device 120A functions as the specifying unit 123. The processing device 120A detects the first obstacle region DA1 indicating a region of the obstacle DO present in the projection target PO in the projection region RM in the captured image GI.

In step S4, the processing device 120A functions as the specifying unit 123. The processing device 120A detects the region other than the first obstacle region DA1 in the projection region RM as the first non-obstacle region PA1 in the captured image GI.

As a result of step S3 and step S4, the processing device 120A specifies the first region FA and the second region SA in the projection target PO.

In step S5, the processing device 120A functions as the calculator 124. The processing device 120A applies the correspondence detected in step S1 to the first obstacle region DA1 detected in step S3 and the first non-obstacle region PA1 detected in step S4 on the camera coordinate system. As a result, the processing device 120A calculates the second obstacle region information indicating the second obstacle region DA2 and the second non-obstacle region information indicating the second non-obstacle region PA2 on the panel coordinate system.

In step S6, the processing device 120A functions as the acquirer 125. The processing device 120A acquires the first image information indicating the original image RI of the projection image PI. Then, the processing device 120A acquires the keystone correction information required for keystone correction.

In step S7, the processing device 120A functions as the corrector 126A. The processing device 120A generates the projection image PI in the panel coordinate system by performing the keystone correction on the original image RI indicated by the first image information acquired in step S6 using the keystone correction information similarly acquired in step S6. Then, in the panel coordinate system, the processing device 120A adjusts the shape of the projection image PI such that the projection image PI falls within the second non-obstacle region PA2 while avoiding the second obstacle region DA2. This correction is an automatic correction that does not involve operations by the user of the projection device 1A.

In step S8, the processing device 120A functions as the determiner 130A. The processing device 120A determines whether the automatic correction of the projection image PI is ended. If a determination result is positive (“YES” in step S8), the processing device 120A executes processing in step S9. If the determination result is negative (“NO” in step S8), the processing device 120A executes the processing in step S7.

In step S9, the processing device 120A functions as the first projection controller 127. The processing device 120A causes the projector 30 to project the corrected projection image PI in the first region FA of the projection target PO.

In step S10, the processing device 120A functions as the generator 128A. The processing device 120A generates the indication image II indicating that the obstacle DO is present in the projection target PO.

In step S11, the processing device 120A functions as the second projection controller 129. The processing device 120A causes the projector 30 to project the indication image II generated in step S10 onto the projection target PO.

In step S12, the processing device 120A functions as the corrector 126A. The processing device 120A further corrects the projection image PI based on an operation on the input device 160 which is performed by the user of the projection device 1A. The correction is a manual correction accompanied by an operation of the user of the projection device 1A.

In step S13, the processing device 120A functions as the determiner 130A. The processing device 120A determines whether the manual correction of the projection image PI is ended. If a determination result is positive (“YES” in step S13), the processing device 120A executes processing in step S14. When the determination result is negative (“NO” in step S13), the processing device 120A executes the processing in step S12.

In step S14, the processing device 120A functions as the second projection controller 129. The processing device 120A causes the projector 30 to end the projection of the indication image II.

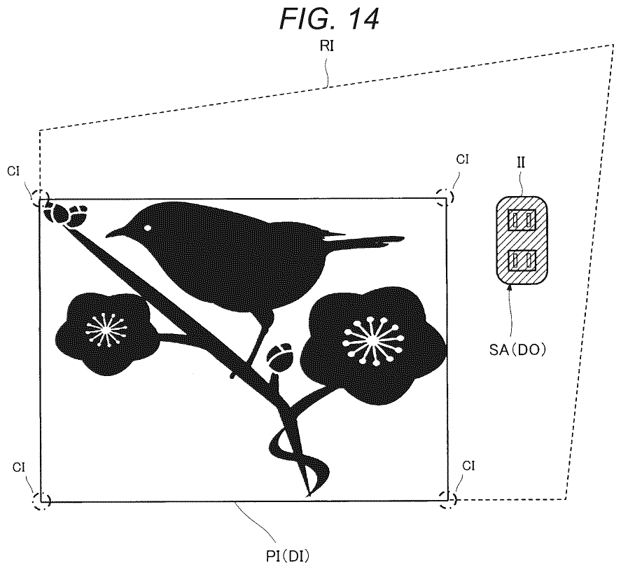

FIG. 14 is a diagram illustrating an example of the projection image PI (the display image DI) and the indication image II which are displayed on the projection target PO during the first operation. In FIG. 14, adjustment icons CI displayed during the manual correction are displayed at four corners of the projection image PI (the display image DI). In FIG. 14, a position where the original image RI is present is indicated by a dotted line. The processing device 120A may function as a display controller (not illustrated) to cause the display device 150 to display the projection image PI (the display image DI), the indication image II, and the adjustment icon CI similar to those in FIG. 14. The projection of the indication image II ends as the manual correction is ended.

### 1-3-2: Second Operation

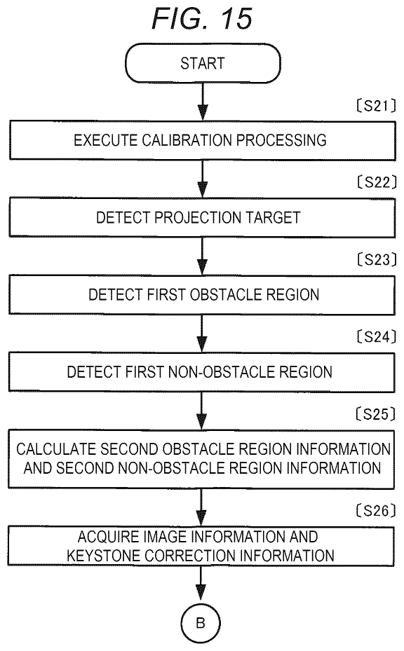

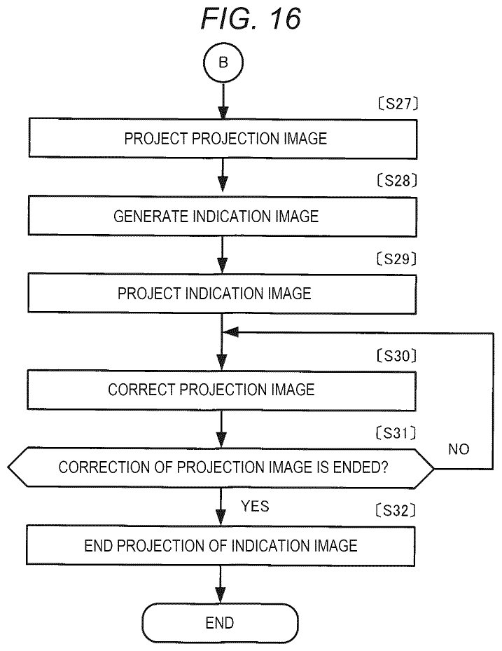

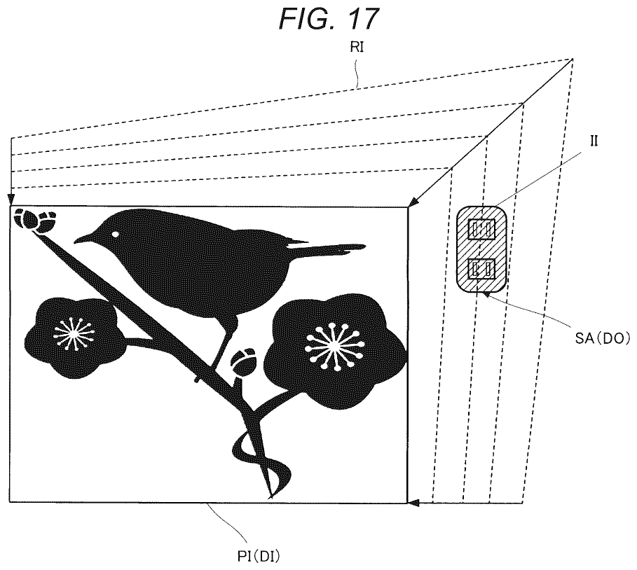

FIGS. 15 and 16 are flowcharts illustrating a second operation of the control device 10A.

Since step S21 to step S26 are the same as step S1 to step S6 in the first operation, the description thereof will be omitted.

In step S27, the processing device 120A functions as the first projection controller 127. The processing device 120A causes the projector 30 to project the projection image PI in the first region FA of the projection target PO.

In step S28, the processing device 120A functions as the generator 128A. The processing device 120A generates the indication image II indicating that the obstacle DO is present in the projection target PO.

In step S29, the processing device 120A functions as the second projection controller 129. The processing device 120A causes the projector 30 to project the indication image II generated in step S28 onto the projection target PO.

In step S30, the processing device 120A functions as the corrector 126A. The processing device 120A generates the projection image PI in the panel coordinate system by performing the keystone correction on the original image RI indicated by the first image information acquired in step S6 using the keystone correction information similarly acquired in step S6. Then, in the panel coordinate system, the processing device 120A adjusts the shape of the projection image PI such that the projection image PI falls within the second non-obstacle region PA2 while avoiding the second obstacle region DA2. This correction is an automatic correction that does not involve operations by the user of the projection device 1A.

In step S31, the processing device 120A functions as the determiner 130A. The processing device 120A determines whether the automatic correction of the projection image PI is ended. If a determination result is positive (“YES” in step S31), the processing device 120A executes processing in step S32. If the determination result is negative (“NO” in step S31), the processing device 120A executes the processing in step S30.

In step S32, the processing device 120A functions as the second projection controller 129. The processing device 120A causes the projector 30 to end the projection of the indication image II.

FIG. 17 is a diagram illustrating an example of the projection image PI (the display image DI) and the indication image II which are displayed on the projection target PO during the second operation. As illustrated in FIG. 17, during the second operation, the projection image PI corrected from the original image RI is displayed in animation as the correction proceeds. While an animation indicating a process of the correction is displayed, the indication image II is displayed. The projection of the indication image II ends as the correction is ended.

### 2: Second Embodiment

### 2-1: Configuration in Second Embodiment

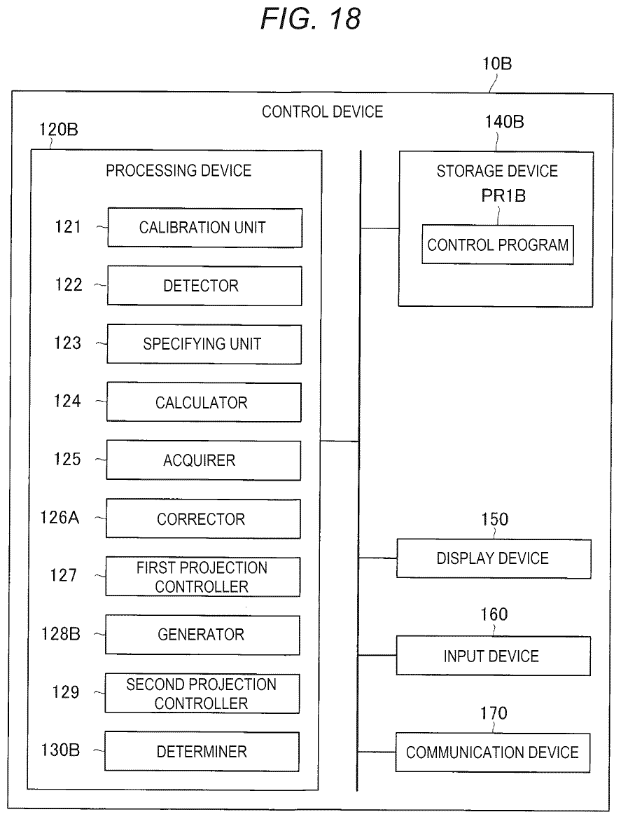

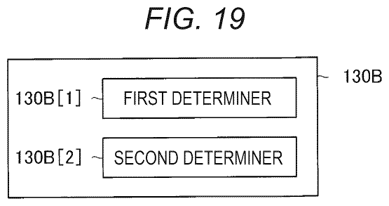

Hereinafter, a projection method and a projection device according to a second embodiment will be described with reference to FIGS. 18 and 19. Hereinafter, for simplification of description, the projection method and the projection device according to the second embodiment will be described below in terms of differences from the projection method and the projection device according to the first embodiment. The same reference numerals will be used for components that are identical to the components included in the projection device according to the first embodiment among components of the projection device according to the second embodiment, and the descriptions of functions thereof may be omitted.

### 2-1-1: Overall Configuration of Projection Device

A projection device 1B according to the second embodiment of the present disclosure includes a control device 10B instead of the control device 10A, unlike the projection device 1A according to the first embodiment. Since an overall configuration of the projection device 1B is the same as the overall configuration of the projection device 1A in other respects, the illustration thereof will be omitted.

### 2-1-2: Overall Configuration of Control Device

FIG. 18 is a block diagram illustrating an example of a configuration of the control device 10B. Unlike the control device 10A, the control device 10B includes a processing device 120B instead of the processing device 120A and a storage device 140B instead of the storage device 140A.

Unlike the storage device 140A, the storage device 140B includes a control program PR1B instead of the control program PR1A.

By reading the control program PR1B from the storage device 140B and executing the control program PR1B, the processing device 120B functions as the calibration unit 121, the detector 122, the specifying unit 123, the calculator 124, the acquirer 125, the corrector 126A, the first projection controller 127, a generator 128B, the second projection controller 129, and a determiner 130B. The control program PR1B may be transmitted from, via a communication network, another device such as a server that manages the control device 10B.

FIG. 19 is a functional block diagram of the determiner 130B. The determiner 130B includes a first determiner 130B[1] and a second determiner 130B[2].

Similarly to the determiner 130A according to the first embodiment, the first determiner 130B[1] determines whether an operation of correcting the projection image PI is ended.

The second determiner 130B[2] determines whether a size of the second region SA is larger than a size of a third region TA that is a region of the projection image PI (the display image DI) in the projection target PO. More specifically, the second determiner 130B[2] determines whether the number of pixels in the second obstacle region DA2 is larger than the number of pixels in the projection image PI in the panel coordinate system. The second determiner 130B[2] determines whether the size of the second region SA is larger than the size of the third region TA in the projection target PO based on a determination result thereof. The third region TA is a region onto which the projection image PI is projected in the first region FA.

In FIG. 18, similarly to the generator 128A, the generator 128B generates the indication image II indicating that the obstacle DO is present in the projection target PO.

The generator 128B changes a type of the indication image II based on the determination result of the second determiner 130B[2]. That is, the type of the indication image II differs depending on a magnitude relationship between the size of the second region SA and the size of the third region TA.

For example, when the size of the second region SA is larger than the size of the third region TA, the indication image II is the line image LN surrounding the second region SA. On the other hand, when the size of the second region SA is equal to or less than the size of the third region TA, the indication image II is the color image PT that fills the second region SA with a single color.

### 2-2: Operation of Control Device

### 2-2-1: First Operation

Since a first operation of the control device 10B is the same as the first operation illustrated in FIGS. 12 and 13 except for the following points, illustration thereof will be omitted.

In step S10 of the first operation of the control device 10B, the processing device 120B functions as the second determiner 130B[2]. The processing device 120B determines whether the size of the second region SA is larger than the size of the third region TA.

The processing device 120B further functions as the generator 128B. The processing device 120B generates the indication image II indicating that the obstacle DO is present in the projection target PO. At this time, the processing device 120B changes the type of the indication image II based on the determination result.

### 2-2-2: Second Operation

Since a second operation of the control device 10B is the same as the second operation illustrated in FIGS. 15 and 16 except for the following points, illustration thereof will be omitted.

In step S28 of the second operation of the control device 10B, the processing device 120B functions as the second determiner 130B[2]. The processing device 120B determines whether the size of the second region SA is larger than the size of the third region TA.

The processing device 120B further functions as the generator 128B. The processing device 120B generates the indication image II indicating that the obstacle DO is present in the projection target PO. At this time, the processing device 120B changes the type of the indication image II based on the determination result.

### 3: Third Embodiment

### 3-1: Configuration in Third Embodiment

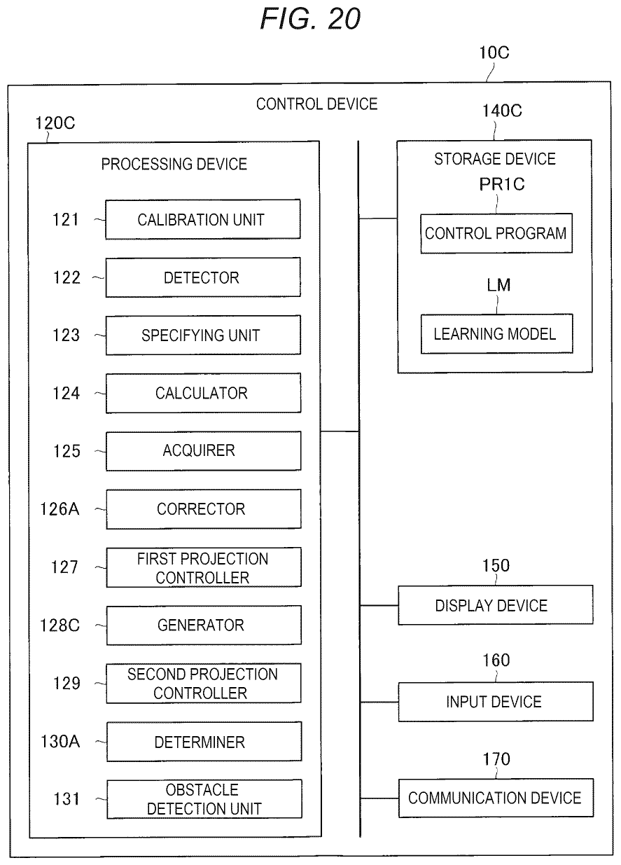

Hereinafter, a projection method and a projection device according to a third embodiment will be described with reference to FIG. 20. Hereinafter, for simplification of description, the projection method and the projection device according to the third embodiment will be described below in terms of differences from the projection method and the projection device according to the first embodiment. The same reference numerals will be used for components that are identical to the components included in the projection device according to the first embodiment among components of the projection device according to the third embodiment, and the descriptions of functions thereof may be omitted.

### 3-1-1: Overall Configuration of Projection Device

A projection device 1C according to the third embodiment of the present disclosure includes a control device 10C instead of the control device 10A, unlike the projection device 1A according to the first embodiment. Since an overall configuration of the projection device 1C is the same as the overall configuration of the projection device 1A in other respects, the illustration thereof will be omitted.

### 3-1-2: Overall Configuration of Control Device

FIG. 20 is a block diagram illustrating an example of a configuration of the control device 10C. Unlike the control device 10A, the control device 10C includes a processing device 120C instead of the processing device 120A and a storage device 140C instead of the storage device 140A.

Unlike the storage device 140A, the storage device 140C includes a control program PR1C instead of the control program PR1A. The storage device 140C further includes a learning model LM.

The learning model LM is a learning model used by an obstacle detection unit 131 to be described later to detect a type of the obstacle DO. The learning model LM is generated by learning training data in a learning phase. The training data used to generate the learning model LM includes a plurality of sets of the captured image GI of the obstacle DO and a type of the obstacle DO. When the obstacle detection unit 131 inputs the captured image GI of the projection target PO to the learning model LM, a type of the obstacle DO present in the projection target PO is output from the learning model LM.

By reading the control program PR1C from the storage device 140C and executing the control program PR1C, the processing device 120C functions as the calibration unit 121, the detector 122, the specifying unit 123, the calculator 124, the acquirer 125, the corrector 126A, the first projection controller 127, a generator 128C, the second projection controller 129, the determiner 130A, and the obstacle detection unit 131. The control program PR1C may be transmitted from, via a communication network, another device such as a server that manages the control device 10C.

The obstacle detection unit 131 detects the type of the obstacle DO present in the projection target PO based on the captured image GI obtained by capturing an image of the projection target PO. Specifically, the obstacle detection unit 131 inputs the captured image GI obtained by capturing an image of the projection target PO to the learning model LM, and acquires the type of the obstacle DO output from the learning model LM.

The obstacle detection unit 131 may detect a color of the obstacle DO present in the projection target PO based on the captured image GI obtained by capturing an image of the projection target PO.

Similarly to the generator 128A, the generator 128C generates the indication image II indicating that the obstacle DO is present in the projection target PO.

The generator 128C changes a type of the indication image II based on the type of the obstacle DO detected by the obstacle detection unit 131. That is, the type of the indication image II differs depending on the type of the obstacle DO.

When the obstacle detection unit 131 detects the color of the obstacle DO, the generator 128C changes the type of the indication image II based on the color of the obstacle DO detected by the obstacle detection unit 131. That is, the type of the indication image II differs depending on the color of the obstacle DO.

### 3-2: Operation of Control Device

### 3-2-1: First Operation

Since a first operation of the control device 10C is the same as the first operation illustrated in FIGS. 12 and 13 except for the following points, illustration thereof will be omitted.

In step S10 of the first operation of the control device 10C, the processing device 120C functions as the obstacle detection unit 131. The processing device 120C detects the type of the obstacle DO present in the projection target PO.

The processing device 120C further functions as the generator 128C. The processing device 120C generates the indication image II indicating that the obstacle DO is present in the projection target PO. At this time, the processing device 120C changes the type of the indication image II based on the type of the obstacle DO.

Alternatively, in step S10 of the first operation of the control device 10C, the processing device 120C may function as the obstacle detection unit 131 to detect the color of the obstacle DO present in the projection target PO.

In this case, the processing device 120C changes the type of the indication image II based on the color of the obstacle DO.

### 3-2-2: Second Operation

Since a second operation of the control device 10C is the same as the first operation illustrated in FIGS. 15 and 16 except for the following points, illustration thereof will be omitted.

In step S28 of the second operation of the control device 10C, the processing device 120C functions as the obstacle detection unit 131. The processing device 120C detects the type of the obstacle DO present in the projection target PO.

The processing device 120C further functions as the generator 128C. The processing device 120C generates the indication image II indicating that the obstacle DO is present in the projection target PO. At this time, the processing device 120C changes the type of the indication image II based on the type of the obstacle DO.

Alternatively, in step S28 of the second operation of the control device 10C, the processing device 120C may function as the obstacle detection unit 131 to detect the color of the obstacle DO present in the projection target PO.

In this case, the processing device 120C changes the type of the indication image II based on the color of the obstacle DO.

### 4: Fourth Embodiment

### 4-1: Configuration in Fourth Embodiment

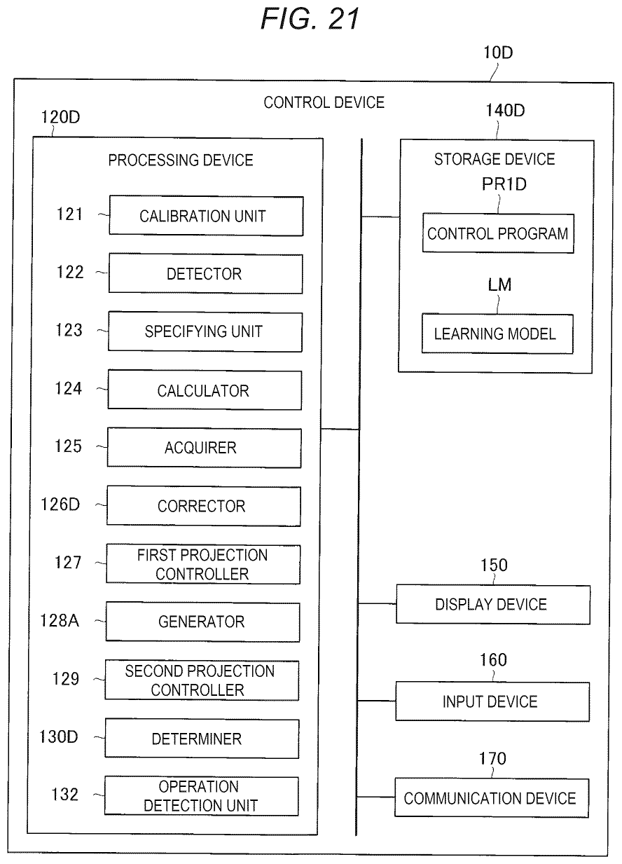

Hereinafter, a projection method and a projection device according to a fourth embodiment will be described with reference to FIGS. 21 to 24. Hereinafter, for simplification of description, the projection method and the projection device according to the fourth embodiment will be described below in terms of differences from the projection method and the projection device according to the first embodiment. The same reference numerals will be used for components that are identical to the components included in the projection device according to the first embodiment among components of the projection device according to the fourth embodiment, and the descriptions of functions thereof may be omitted.

### 4-1-1: Overall Configuration of Projection Device

A projection device 1D according to the fourth embodiment of the present disclosure includes a control device 10D instead of the control device 10A, unlike the projection device 1A according to the first embodiment. Since an overall configuration of the projection device 1D is the same as the overall configuration of the projection device 1A in other respects, the illustration thereof will be omitted.

### 4-1-2: Overall Configuration of Control Device

FIG. 21 is a block diagram illustrating an example of a configuration of the control device 10D. Unlike the control device 10A, the control device 10D includes a processing device 120D instead of the processing device 120A and a storage device 140D instead of the storage device 140A.

Unlike the storage device 140A, the storage device 140D includes a control program PR1D instead of the control program PR1A.

By reading the control program PR1D from the storage device 140D and executing the control program PR1D, the processing device 120D functions as the calibration unit 121, the detector 122, the specifying unit 123, the calculator 124, the acquirer 125, a corrector 126D, the first projection controller 127, the generator 128A, the second projection controller 129, a determiner 130D, and an operation detection unit 132. The control program PR1D may be transmitted from, via a communication network, another device such as a server that manages the control device 10D.

The operation detection unit 132 detects an operation of a user based on a captured video GM of the projection target PO and the user of the projection device 1D located in the vicinity of the projection target that is captured by the image-capturing device 20. More specifically, the operation detection unit 132 detects the operation performed by the user using an indicator. The indicator is, for example, a hand of the user, an index finger, or a tool held by the user. The term “vicinity” described above means a range in which the user is included in the captured video GM in which the projection target PO is captured.

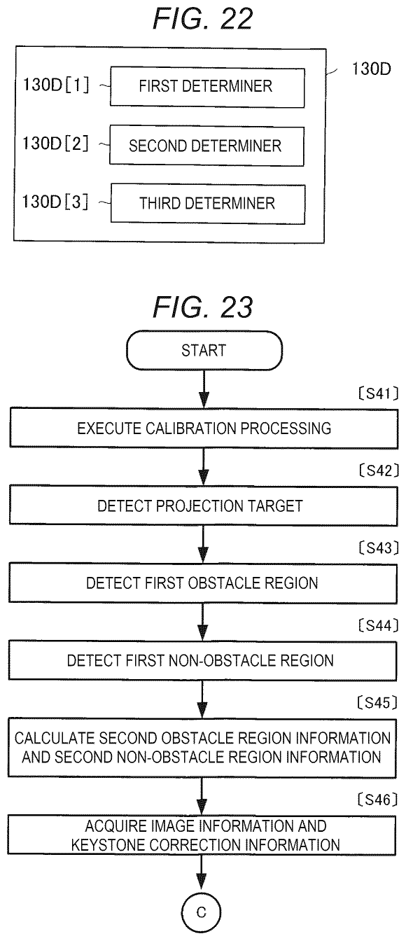

FIG. 22 is a functional block diagram of the determiner 130D. The determiner 130D includes a first determiner 130D[1], a second determiner 130D[2], and a third determiner 130D[3].

Similarly to the determiner 130A according to the first embodiment, the first determiner 130D[1] determines whether an operation of correcting the projection image PI is ended.

The second determiner 130D[2] determines whether the indication image II is illustrated by the indicator. The determination is an example of a “first determination”.

The third determiner 130D[3] determines whether the indicator is performing a predetermined operation. The determination is an example of a “second determination”. The predetermined operation is an example of the “first operation”.

Similarly to the corrector 126A, the corrector 126D generates the projection image PI in the panel coordinate system by performing the keystone correction on the original image RI indicated by the first image information acquired by the acquirer 125 using the keystone correction information similarly acquired by the acquirer 125. Then, in the panel coordinate system, the corrector 126D adjusts the shape of the projection image PI such that the projection image PI falls within the second non-obstacle region PA2 while avoiding the second obstacle region DA2.

Then, when both the result of the first determination and the result of the second determination are positive, the corrector 126D changes a size of the projection image PI such that the projection image PI is projected in the first region FA and the second region SA.

For example, when the projection image PI (the display image DI) and the indication image II illustrated in FIGS. 7 to 10 are displayed on the projection target PO, if the user of the projection device 1D performs an operation of pointing the indication image II with an index finger in front of the projection target PO and then shaking the index finger, the projection image PI (the display image DI) is enlarged to cover a part of the first region FA and the second region SA.

### 4-2: Operation of Control Device

### 4-2-1: First Operation

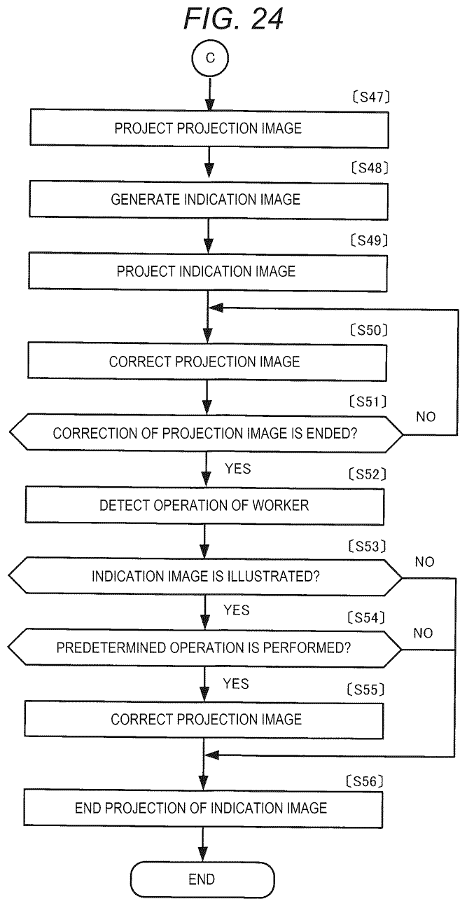

FIGS. 23 and 24 are a flowchart illustrating the first operation of the control device 10D.

Since step S41 to step S50 are the same as step S21 to step S30 in the second operation according to the first embodiment, the description thereof will be omitted.

In step S51, the processing device 120D functions as the first determiner 130D[1]. The processing device 120D determines whether an automatic correction of the projection image PI is ended. When a determination result is positive (“YES” in step S51), the processing device 120D executes processing in step S52. When the determination result is negative (“NO” in step S51), the processing device 120D executes the processing in step S50.

In step S52, the processing device 120D functions as the operation detection unit 132. The processing device 120D detects the operation of the user based on the captured video GM of the projection target PO and the user of the projection device 1D located in the vicinity of the projection target that is captured by the image-capturing device 20. More specifically, the processing device 120D detects the operation performed by the user using the indicator.

In step S53, the processing device 120D functions as the second determiner 130D[2]. The processing device 120D determines whether the indication image II is illustrated by the indicator. When a determination result is positive (“YES” in step S53), the processing device 120D executes processing in step S54. When the determination result is negative (“NO” in step S53), the processing device 120D executes processing in step S56.

In step S54, the processing device 120D functions as the third determiner 130D[3]. The processing device 120D determines whether the indicator is performing the predetermined operation. When a determination result is positive (“YES” in step S54), the processing device 120D executes processing in step S55. When the determination result is negative (“NO” in step S54), the processing device 120D executes the processing in step S56.

In step S55, the processing device 120D functions as the corrector 126D. The processing device 120D changes the size of the projection image PI such that the projection image PI is projected in the first region FA and the second region SA.

In step S56, the processing device 120D functions as the second projection controller 129. The processing device 120D causes the projector 30 to end the projection of the indication image II.

### 5: Modifications

The embodiments exemplified above can be variously deformed. Specific aspects of deformations applicable to the embodiments described above will be exemplified below. Two or more aspects freely selected from the examples given below can be combined together as appropriate to the extent that no contradiction occurs.

### 5-1: Modification 1

At least a part of the operations performed by the control device 10A to the control device 10D may be executed by at least one of the processing device 320 included in the projector 30 or a processing device included in the image-capturing device 20.

### 6. Summary of Present Disclosure

The present disclosure will be summarized below in the form of appendixes.

(Appendix 1) A projection method including: detecting a projection target; specifying a first region in which an obstacle is not present in the projection target and a second region in which the obstacle is present in the projection target based on a result of detecting the projection target; projecting a first projection image in at least a part of the first region; and projecting a second projection image that is different from the first projection image and indicates that the obstacle is present in the projection target.

Accordingly, it becomes clear which object the projection device 1 recognizes as the obstacle DO, and the user can determine whether appropriate control is being performed. More specifically, the projection device 1 projects the projection image PI in the first region FA in which the obstacle DO is not present, and projects the indication image II indicating that the obstacle DO is present separately from the projection image PI. By visually recognizing the indication image II, the user can specifically grasp which object the projection device 1 recognizes as the obstacle DO.

(Appendix 2) The projection method according to Appendix 1, in which the second p projection image is projected in the second region.

Accordingly, the projection device 1 projects the projection image PI in the first region FA in which the obstacle DO is not present, and projects the indication image II indicating that the obstacle DO is present in the second region SA in which the obstacle DO is present. By visually recognizing the indication image II, the user can specifically grasp which object the projection device 1 recognizes as the obstacle.

(Appendix 3) The projection method according to Appendix 1 or Appendix 2, in which the second projection image is a line image that surrounds at least a part of the second region.

Accordingly, the user can easily determine the dimension of the second region SA. Further, since the indication image II is merely a line image LN, it is possible to reduce a degree of influence caused by the indication image II on the visual recognition of the projection image PI by the user.

(Appendix 4) The projection method according to any one of Appendix 1 to Appendix 3, further including: determining whether a size of the second region is larger than a size of a third region in the first region, in which the first projection image is projected, in which a type of the second projection image differs depending on a magnitude relationship between the size of the second region and the size of the third region.

Accordingly, the projection device 1 can change the type of the indication image II according to the dimension of the second region SA. As a result, the projection device 1 can control the degree of influence of the indication image II on the visual recognition of the projection image PI by the user, depending on the magnitude relationship between the dimension of the second region SA and the dimension of the third region TA.

(Appendix 5) The projection method according to Appendix 4, in which when the size of the second region is larger than the size of the third region, the second projection image is a line image surrounding the second region, and when the size of the second region is equal to or less than the size of the third region, the second projection image is a color image that fills the second region with a single color.

Accordingly, when the size of the second region SA is larger than the size of the third region TA, the line image LN is projected as the indication image II, whereby the projection device 1 can prevent the indication image II from being more conspicuous than necessary.

(Appendix 6) The projection method according to any one of Appendix 1 to Appendix 5, further including: detecting a color of the obstacle, in which a color of the second projection image differs depending on the color of the obstacle.

Accordingly, since the color of the indication image II differs depending on the color of the obstacle DO, the user can more easily recognize the presence of the obstacle DO.

(Appendix 7) The projection method according to any one of Appendix 1 to Appendix 6, further including: detecting a type of the obstacle, in which a type of the second projection image differs depending on the type of the obstacle.

Accordingly, since the type of the indication image II differs depending on the type of the obstacle DO, the user can more easily recognize the presence of the obstacle DO.

(Appendix 8) The projection method according to any one of Appendix 1 to Appendix 7, further including: adjusting a shape of the first projection image, in which the second projection image is projected during the adjustment of the shape of the first projection image, and is not projected after a time point at which the adjustment of the shape of the first projection image is ended.

Accordingly, since the indication image II is not projected after a time point at which the adjustment of the appearance of the projection image PI is ended, which is a time point at which the viewing of the projection image PI is started, it is possible to reduce the degree of influence on the viewing of the projection image PI caused by the indication image II.

(Appendix 9) The projection method according to any one of Appendix 1 to Appendix 8, in which a projection mode of the second projection image changes during an adjustment of a shape of the first projection image.

Accordingly, the indication image II functions not only as a means for the user to grasp the region in which the obstacle DO is present in the projection target PO, but also as a means for grasping that the projection image PI is being subjected to a geometric correction. As a result, the usability of the projection device 1 by the user is further improved.

(Appendix 10) The projection method according to Appendix 1, in which a projection mode of the second projection image changes as time passes.

Accordingly, by changing the projection mode of the indication image II over time, it is possible to increase the possibility that the indication image II is perceived by the user. As a result, the user can more easily grasp which region is recognized as a region in which the obstacle is present in the projection target PO.

(Appendix 11) The projection method according to Appendix 1, further including: performing a first determination as to whether the second projection image is indicated by an indicator; performing a second determination as to whether the indicator is performing a first operation; and changing a size of the first projection image such that the first projection image is projected in the first region and the second region when both a result of the first determination and a result of the second determination are positive.

Accordingly, the projection device 1 can change the size of the projection image PI in the projection target PO according to the operation of the indicator. That is, when the user determines that the second region SA is also a projection region of the projection image PI, the user can designate the size of the projection image PI in the projection target PO according to the operation of the indicator.

(Appendix 12) A projection device including: a processor configured to control detection of a projection target, specifying of a first region in which an obstacle is not present in the projection target and a second region in which the obstacle is present in the projection target based on a result of detecting the projection target, projection of a first projection image in a part or an entirety of the first region, and projection of a second projection image that is different from the first projection image and indicates that the obstacle is present in the projection target.

Accordingly, it becomes clear which object the projection device 1 recognizes as the obstacle DO, and the user can determine whether appropriate control is being performed. More specifically, the projection device 1 projects the projection image PI in the first region FA in which the obstacle DO is not present, and projects the indication image II indicating that the obstacle DO is present separately from the projection image PI. By visually recognizing the indication image II, the user can specifically grasp which object the projection device 1 recognizes as the obstacle DO.

What is claimed is:

1. A projection method comprising:
detecting a projection target;
specifying a first region in which an obstacle is not present in the projection target and a second region in which the obstacle is present in the projection target based on a result of detecting the projection target;
projecting a first projection image in at least a part of the first region; and
projecting a second projection image that is different from the first projection image and indicates that the obstacle is present in the projection target.

2. The projection method according to claim 1, wherein
the second projection image is projected in the second region.

3. The projection method according to claim 1, wherein
the second projection image is a line image that surrounds at least a part of the second region.

4. The projection method according to claim 1, further comprising:
determining whether a size of the second region is larger than a size of a third region in the first region, the third region being a region in which the first projection image is projected, wherein
a type of the second projection image differs depending on a magnitude relationship between the size of the second region and the size of the third region.

5. The projection method according to claim 4, wherein
when the size of the second region is larger than the size of the third region, the second projection image is a line image surrounding the second region, and
when the size of the second region is equal to or less than the size of the third region, the second projection image is a color image that fills the second region with a single color.

6. The projection method according to claim 1, further comprising:
detecting a color of the obstacle, wherein
a color of the second projection image differs depending on the color of the obstacle.

7. The projection method according to claim 1, further comprising:
detecting a type of the obstacle, wherein
a type of the second projection image differs depending on the type of the obstacle.

8. The projection method according to claim 1, further comprising:
adjusting a shape of the first projection image, wherein
the second projection image is projected during the adjustment of the shape of the first projection image, and is not projected after a time point at which the adjustment of the shape of the first projection image is ended.

9. The projection method according to claim 1, wherein
a projection mode of the second projection image changes during an adjustment of a shape of the first projection image.

10. The projection method according to claim 1, wherein
a projection mode of the second projection image changes as time passes.

11. The projection method according to claim 1, further comprising:
performing a first determination as to whether the second projection image is indicated by an indicator;
performing a second determination as to whether the indicator is performing a first operation; and
changing a size of the first projection image such that the first projection image is projected in the first region and the second region when both a result of the first determination and a result of the second determination are positive.

12. A projection device comprising:
a processor configured to control
detection of a projection target,
specifying of a first region in which an obstacle is not present in the projection target and a second region in which the obstacle is present in the projection target based on a result of detecting the projection target,
projection of a first projection image in a part or an entirety of the first region, and
projection of a second projection image that is different from the first projection image and indicates that the obstacle is present in the projection target.
